(19) United States
(12) Patent Application Publication
(10) Pub. No.: US 2006/0271464 A1
(43) Pub. Date: Nov. 30, 2006

(54) CENTRALIZED LOAN APPLICATION AND PROCESSING

(76) Inventor: Michael Anthony Colabucci, Upper Marlboro, MD (US)

Correspondence Address: MILES & STOCKBRIDGE PC, 1751 PINNACLE DRIVE, SUITE 500, MCLEAN, VA, 22102-3833, US

(21) Appl. No.: 11/420,326

(22) Filed: May 25, 2006

Related U.S. Application Data
(60) Provisional application No. 60/684,187, filed on May 25, 2005.

(51) Int. Cl. G06Q 40/00

(52) U.S. Cl. 705/35

(57) ABSTRACT

A credit operations center is connected to provide functionality, monitoring and control over one or more locations, such as a store that may sell goods or services. In conjunction with the purchase of these goods or services, it may be necessary to secure credit for their purchase. To assist with the processing of a credit application, each location is provided with one or more mechanisms to facilitate entry of credit application information. For example, these systems can be more traditional in nature and include scanners and fax machines or more sophisticated and entirely electronic and secure such that a user can be prompted for all the necessary information to apply for a loan. This information is capable of being forwarded electronically to a credit operations center for processing.

### FIELD OF THE INVENTION

An exemplary embodiment of this invention generally relates to processing credit applications. In particular, an exemplary embodiment of this invention relates to a centralized credit operations center(s) that is capable of processing credit applications from one or more locations. Each location can have the capability of allowing for an interview to be set up via video conference between a loan applicant and a credit officer.

### SUMMARY

Exemplary aspects of the present invention relate to a centralized credit operations center. The credit operations center allows full functionality, monitoring and control over one or more locations, such as a store that may sell goods or services.

In conjunction with the purchase of goods or services, it may be necessary to secure credit for their purchase. To assist with the processing of a credit application, each location is provided with one or more mechanisms to facilitate entry of credit application information. For example, these systems can be more traditional in nature and include scanners and fax machines or more sophisticated and entirely electronic such that a user can be prompted for all the necessary information to apply for a loan. This information is capable of being forwarded electronically to a credit operations center.

With the ever-increasing concerns over privacy and security, an exemplary aspect of the present invention additionally provides complete control and management of sensitive data. For example, sensitive data can be received and stored electronically as well as optionally encrypted and communicated over a secure network(s). Thus, only persons authorized to come into contact with the sensitive data would be eligible to do so. For example, in an automotive context, at least the entire “deal jacket” can be electronic thereby eliminating the more traditional paper based deal jacket.

### BRIEF DESCRIPTION OF THE DRAWINGS

FIG. 1 is a functional block diagram illustrating an exemplary embodiment of the centralized credit processing system according to this invention;

FIG. 2 is a functional block diagram illustrating an exemplary embodiment of the electronic credit application system according to this invention;

FIG. 3 is a flowchart illustrating an exemplary embodiment of the credit application and approval process according to this invention;

FIG. 4 illustrates in greater detail block S110 of FIG. 3;

FIG. 5 is a flowchart illustrating an exemplary embodiment of the surveillance capabilities of the system according to this invention; and

FIGS. 6-12 represent exemplary user interfaces that are used in conjunction with the centralized credit processing system.

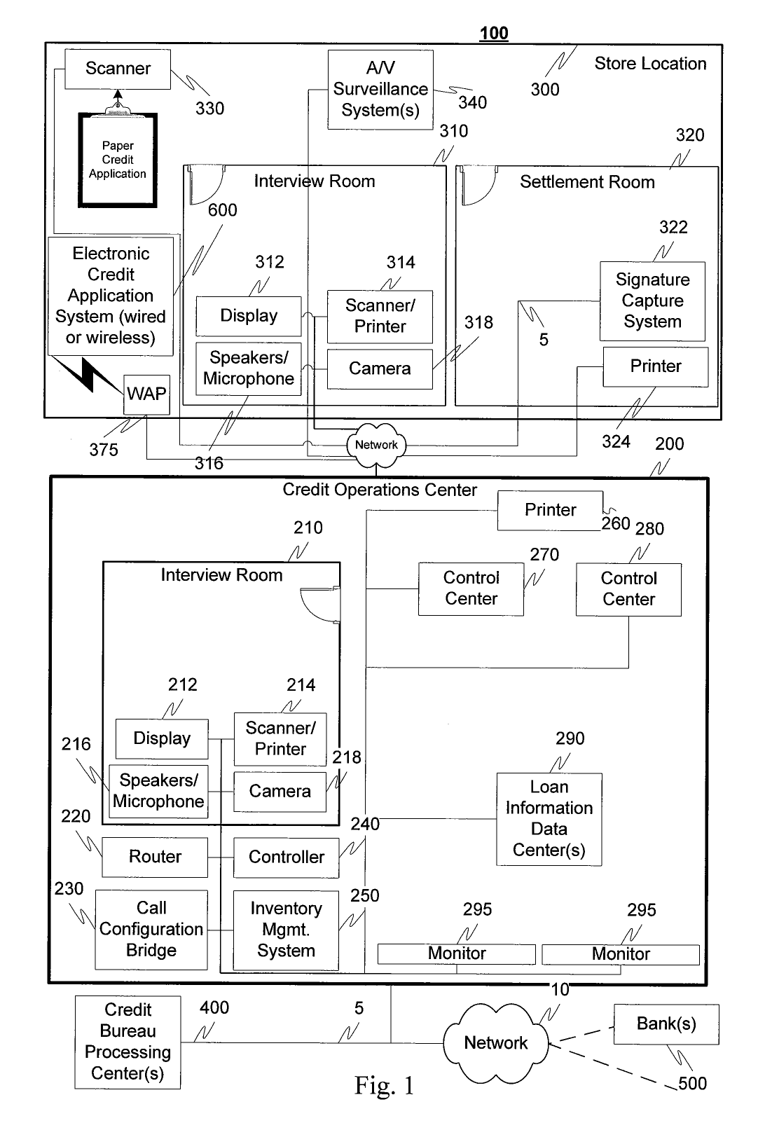

### DETAILED DESCRIPTION

The centralized credit processing system 100 comprises one or more store locations 300, a credit operations center 200, a credit bureau processing center 400 and one or more banks 500, interconnected by one or more wired and/or wireless links 5 and networks 10.

The one or more exemplary store locations 300 comprise an interview room 310, a settlement room 320, a scanner 330, an audio/video surveillance system 340, and one or more electronic credit application systems 600. The exemplary interview room 310 comprises a display 312, a scanner 314, speakers and microphone 316 and a camera 318. The exemplary settlement room 320 includes a signature capture system 322 and a printer 324.

The exemplary credit operations center 200 comprises an interview room 210, which itself comprises a display 212, speakers and microphone 216, printer 214 and camera 218. The exemplary credit operations center 200 further includes one or more printers 260, one or more control centers 270 and 280, one or more loan information data centers 290, one or more monitors 295, a router 220, a call configuration bridge 230, a controller 240, and an inventory management system 250, which includes a database. The exemplary credit operations center 200 is connected via links 5 to one or more credit bureau processing centers 400 and banks 500 via the one or more networks 10.

The exemplary systems and methods of this invention will be described in relation to a centralized credit processing system. However, to avoid unnecessarily obscuring the present invention, the following description omits well-known structures, procedures and devices. For the purposes of explanation, numerous specific details are set forth in order to provide a thorough understanding of the present invention. It should be appreciated, however, that the present invention may be practiced in a variety of ways beyond these specific details. For example, while the components of the various systems are shown collocated, the components can be rearranged in any fashion and/or distributed over a distributed network. Furthermore, the specific number of devices illustrated is for illustrative purposes only and can obviously be scaled as appropriate.

In operation, a customer fills out a credit application either in the traditional manner, which is then scanned (and optionally processed with optical character recognition) via scanner 330 and forwarded to the credit operations center 200, or via the electronic credit application system 600. The electronic credit operation system 600 records the customer's input and, via wired or wireless communication and optionally in cooperation with the wireless access point (WAP) 375, forwards the information to the credit operations center 200. In additional to credit information, the customer could also be asked for any other type of information that could be used for such items as marketing, customer feedback, demographic tracking, or in general, any type of information.

Upon receipt of the credit application, the credit operations center 200 initiates the running of a credit bureau by the credit bureau processing center 400. The credit bureau is then forwarded electronically to one or more of the control centers 270 and/or to the printer 260. The printer 260 can be equipped with, for example, a plurality of different colored papers and/or custom headers that allows quick and easy identification of, for example, one or more of the store location from which the credit application originated, applicant name, salesperson information, store name, credit score, product or service to be purchased, or the like.

With the completed credit bureau, one or more credit officers located at the one or more control centers 270 and 280 review the credit bureau to determine if the loan applicant has sufficient credit for the desired merchandise and/or service. If there are no credit problems, and assuming acceptable terms and goods/services can be agreed on, the purchase can be completed.

An exemplary aspect of this invention also allows, in conjunction with the signature capture system 322 and printer 324, the ability to electronically capture information, such as a signature or any other relevant information to, for example, finalize a purchase agreement that could also be electronically and securely stored in a comparable fashion to that discussed in relation to the electronic credit application system 600. Additionally, finalized contracts and, if appropriate, related documentation, can be printed from the credit operations center 200 at the printer 324 for signature by the loan applicant.

If there appears to be credit issues, the credit officers can determine the amount the loan applicant qualifies for, if any, and can, for example, run an inventory cross-check to determine what products are currently available to the customer based on the prequalification amount. This information can, for example, be transmitted to sales staff located at the store location 300 and, for example, shown to the loan applicant. This inventory cross-check is not limited to those with credit issues, but can be available to any purchaser at any stage of the process.

In making the determination regarding what a loan applicant qualifies for, it may be determined that additional clarification of information in the credit application and/or an interview with the loan applicant are needed. If an interview is needed, an interview is initiated and the loan applicant is invited into the interview room 310. In the interview room 310, the loan applicant, with the assistance of display 312, speakers and microphone 316 and camera 318, enters into a video conference with one or more credit officers located in the interview room 210. Similar to the interview room 310, the interview room 210 has a display 212, microphone and speakers 216 and camera 218 that are in communication with the interview room 310. The two interview rooms thus provide a secure and confidential means for allowing the loan applicant to speak directly to and exchange information with the credit officer.

During the interview, the loan applicant can be requested to supply additional documentation or explanation regarding the credit application and, if appropriate, supporting documentation scanned in via the scanner 314 which can then be stored, forwarded electronically and/or printed on printer 214. The interview room 210 can also include a computer which may or may not also include a portion of the functionality of the control center 270 but could also allow the credit office to interact with any of the data and/or functionality of the centralized credit processing system.

Once all the necessary information is acquired from the loan applicant by the credit officer, the credit officer again makes the determination as to whether there is sufficient information to process and complete a loan application. Assuming acceptable terms and goods and/or services can be found, the process is then completed as discussed above.

To facilitate the real-time exchange of information that occurs between the two interview rooms, the router 220 and call configuration bridge 230, in conjunction with a controller 240 are used to establish real-time video conferences between the interview rooms.

Assuming the loan applicant has found suitable goods, and has been approved to receive credit, the finalized credit application, terms of sale and related loan information are entered into the loan information data center 290 and forwarded to one or more banks 500 for funding. Additionally, the financing agreement is forwarded from the credit operations center 200 to the settlement room 320 and presented to the loan applicant who either provides an electronic signature via the signature capture system 322 or a signature on a financing agreement that was printed on the printer 324, thereby completing the purchase.

In addition to the above functionality, the control centers 270 are capable of displaying on the one or more monitors 295 audio and/or video information from the one or more store locations that is captured by the A/V surveillance system(s) 340 and/or the interview room cameras. For example, the A/V surveillance systems can be one or more video cameras mounted at a store location, in a parking lot(s), or in general at any location(s) at which surveillance is desired—thereby allowing the credit operations center 200 to monitor activity at any one or more of the store locations 300, interview rooms and optionally the settlement room.

The control centers also have control over the A/V surveillance system(s) 340 including but not limited to: turning on and off, resetting, pan, zoom, volume, recording, focus, brightness, contrast, data rate, and the like. Similar control can be extended to the camera 318 in the interview room 210/310 thereby allowing the credit officer/interviewer to make adjustments to the camera as necessary.

The monitors 295, in cooperation with the call configuration bridge 230 and controller 240, are capable of being customized such that one or more A/V feeds from one or more surveillance systems 340 and interview rooms can be displayed. For example, the video feeds from the surveillance systems 340 can be tiled on one or more of the monitors 295 to allow for remote monitoring of a plurality of different surveillance system locations.

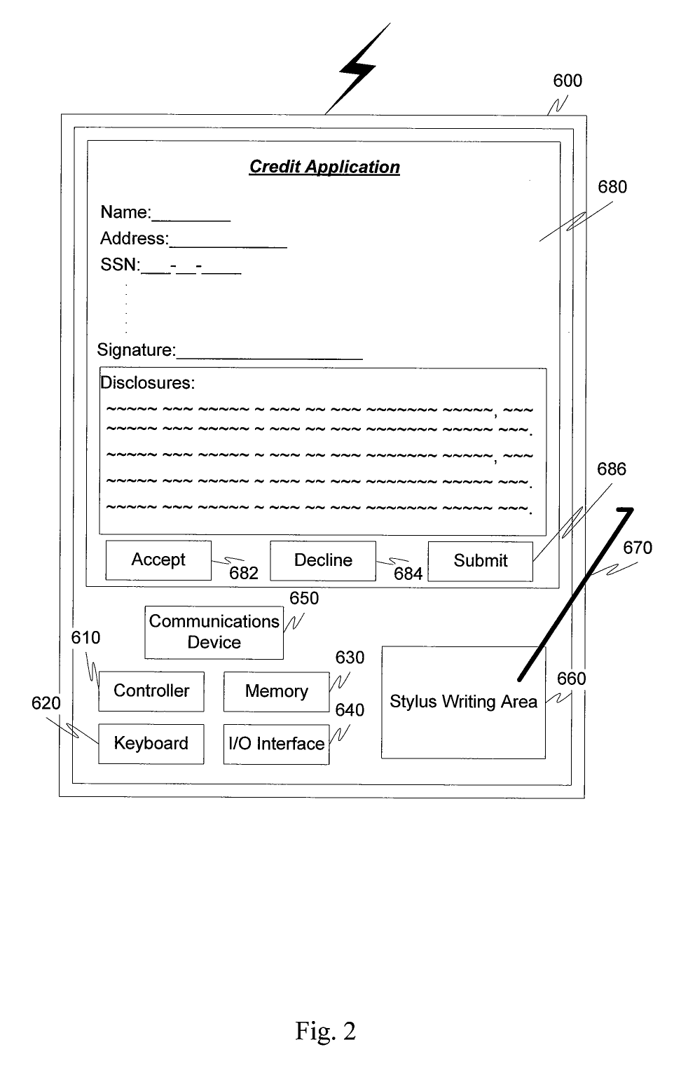

FIG. 2 illustrates in greater detail the electronic credit application system 600. In particular, the electronic credit application system 600 comprises a controller 610, optionally a keyboard 620, a memory 630, an I/O interface 640, communications device 650, an optional stylus writing area 660 and associated stylus 670 and a user interface window 680. The user interface window 680 comprises various electronic information as well as one or more selectable buttons such as an “Accept” button 682 “Decline” button 684 and “Submit” button 686. It should be appreciated however that the content of these buttons can be altered as appropriate depending on, for example, the type of credit application, the goods and/or services, or the like.

The electronic credit application system 600 can be configured in a manner similar to a personal digital assistant and/or point of sale electronic interface, which is capable of displaying various information to a loan applicant. Furthermore, the electronic credit application system 600 is capable of capturing information such as the name, address, signature, or any other information entered by the loan applicant. This information can be entered via, for example, one or more of the keyboard 620, the stylus 670 and stylus writing area 660, voice recognition (not shown), or the like. The captured information can then be forwarded, with the cooperation of the I/O interface 640 and communication device 650, to the credit operations center 200.

It should be readily appreciated that the electronic credit application system 600 need not necessarily communicate directly with the credit operations center 200 but could communicate via one or more networks (not shown) and/or via additional hardware such as routers, bridges, switches, repeaters, and the like, that thereby allow the information received by the electronic credit application system 600 to be forwarded to the credit operations center 200. Furthermore, it should be appreciated that any information entered into the electronic credit application system 600 can be encrypted or otherwise protected to allow for secure communication to the credit operations center 200.

The electronic credit application system 600 is further capable of displaying specific information, such as disclosures, product or service information, product options, advertisements, or in general any information to the loan applicant. The loan applicant must then accept or decline the disclosures by selecting the appropriate button, the selection thereof being recorded and optionally acknowledged. Upon completion of data entry into the electronic credit application system 600 by the loan applicant, and acceptance of all disclosures (if any) the loan applicant can select the submit button 686 at which time the information is forwarded to the credit operations center 200. The electronic credit application entered via the electronic credit application system 600 can be stored in the credit operation centers 200 in a database and/or, for example, in a database at the loan information data center 290. This information can be secured via, for example, well known encryption techniques and/or password protected.

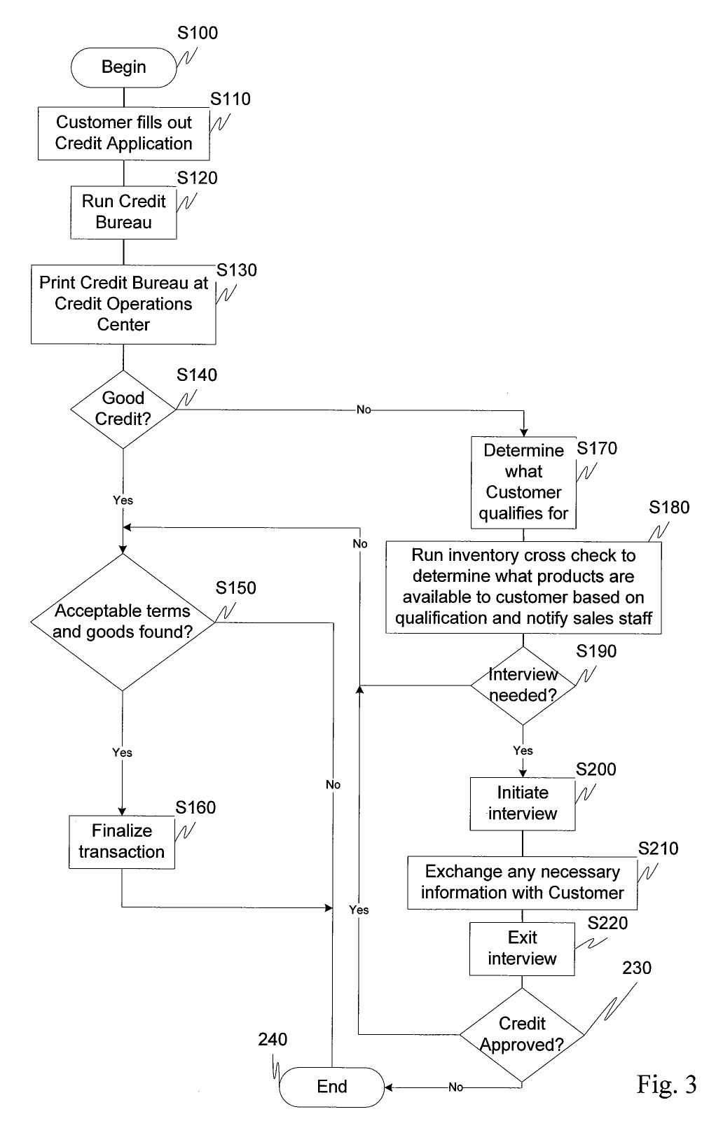

FIG. 3 illustrates an exemplary embodiment of the overall flow of the centralized credit processing system. In particular, control begins as step S100 and continues to step S110. In step S110, the customer fills out a credit application. Next, in step S120, a credit bureau is run. Then, in step S130 a credit bureau is forwarded to the credit operations center and can, for example, be printed. Control then continues to step S140.

In step S140, a determination is made whether the credit application is sufficient for the extension of credit. If so, control continues to step S150 where a determination is made whether acceptable terms and goods and/or services have been found. If acceptable terms, goods, and/or services have been found, control continues to step S160. Otherwise, control jumps to step S230 where the control sequence ends.

In step S160 the transaction is finalized and control continues to step S240 where the control sequence ends.

In step S170, it is determined what goods/services the loan applicant is qualifies to purchase. The available goods/services based on a prequalification amount can then, for example, be displayed to the loan applicant. More specifically, next, in step S180, an optional inventory cross-check can be performed and communicated to, for example, the sales person such that the sales person and the loan applicant can be aware of what products and/or services are available based on the qualification amount. Then, in step S190, a determination is made whether an interview is needed. If an interview is not needed, control jumps back to step 150. Otherwise, control continues to step S200 where the interview is initiated.

Next, in step S210, the real-time video conference is initiated and any necessary information is exchanged between the loan applicant and the interviewer with the cooperation of one or more of the scanner, camera, speakers and microphone, and display device. Upon obtaining any appropriate information, the interview is exited at step S220. In step S230, a determination is made whether credit will be extended. If credit is to be extended control jumps to step S150. Otherwise control continues to step S240 where the control sequence ends.

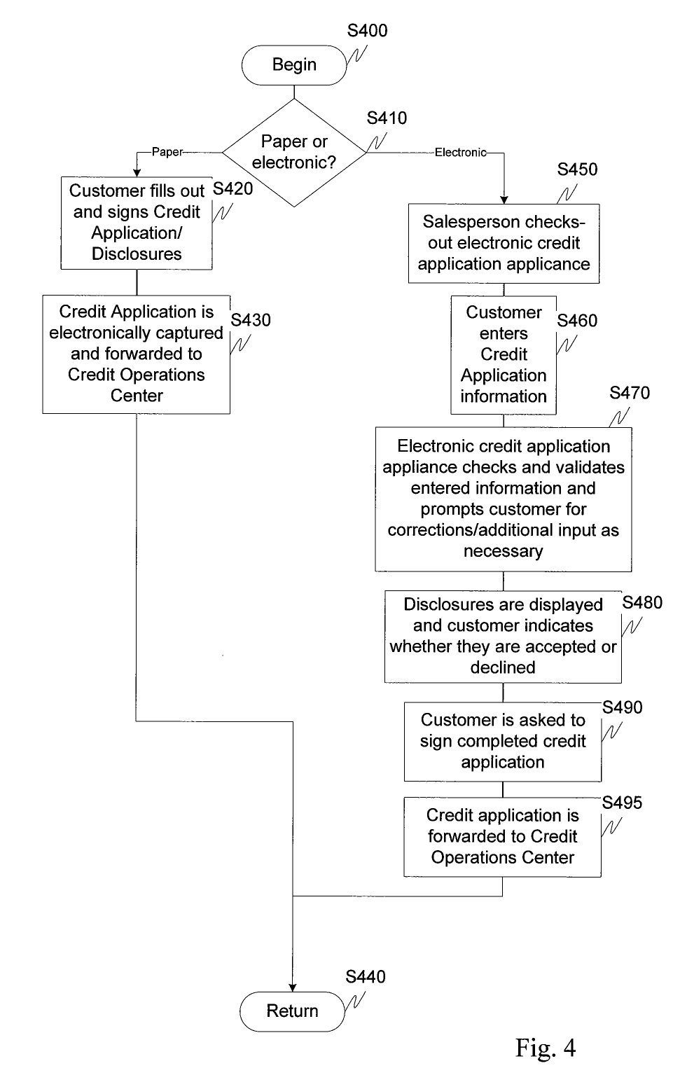

FIG. 4 outlines in greater detail the credit application step S11O of FIG. 3. In particular, control begins in step S400 and continues to step S410. In step S410 a determination is made whether a credit application will be filled out on paper or electronically. If the credit application is to be filled out on paper, control continues to step S420 where the customer fills out and signs the credit application and any related documentation which is then electronically captured in step S430 and forwarded to the credit operations center. Control then continues to step S440 where the control sequence returns to step S120.

Alternatively, if the credit application is to be filled out electronically, control jumps to step S450 where a sales person can optionally check-out an electronic credit application system. For example, upon the sales person checking-out the electronic credit application system, the credit operation's center can monitor which sales person has checked out the electronic credit application system and associate that information with a loan applicant's credit application. Next, in step 460, the customer enters the credit application information. Then, in step S470, the electronic credit application system can check and validate the entered information and prompt the customer for corrections and/or additional information as necessary. Then, in step S480, information such as disclosures can be displayed and the loan applicant provided with interfaces indicating whether these disclosures are accepted or declined. Control then continues to step S490.

In step S490, the loan applicant is asked to sign the completed credit application, which is then forwarded, in step S495, to the credit operations center. Control then continues to step S440 where the control sequence ends.

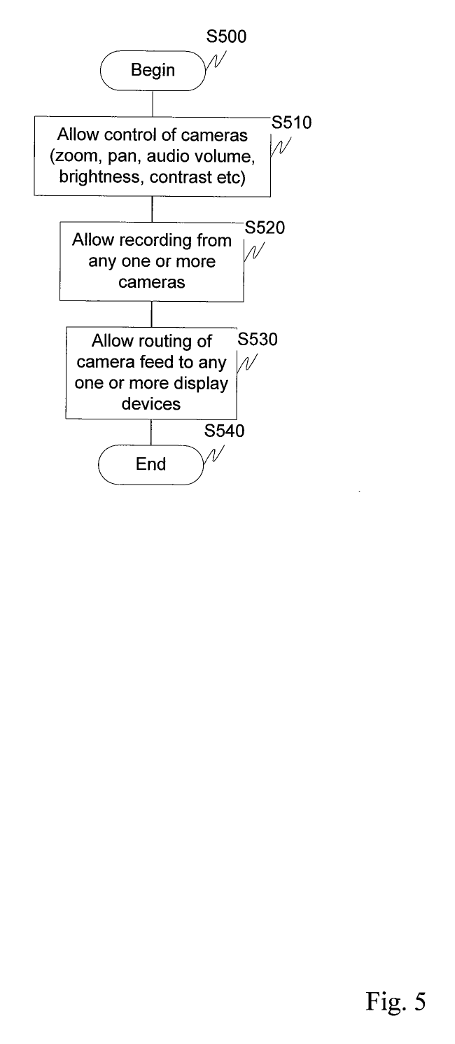

FIG. 5 illustrates an exemplary method for controlling surveillance from the credit operations center. In particular, control begins in step S500 and continues to step S510. In step S510, features, such as zoom, pan, focus, audio volume, brightness, contrast, and the like, can be controlled by the credit operations center and, in particular the control center, at any one or more of the A/V surveillance systems. Furthermore, and in cooperation with a call configuration bridge and router, one or more of the feeds from these video surveillance systems can be initiated and displayed on one or more of the monitors in the credit operations center and, as indicated in step S520, recorded in the credit operations center in a storage device. Then, in step S530, any feed(s) from any location can be configured, formatted and routed to any destination. Control then continues to step S540 where the control sequence ends.

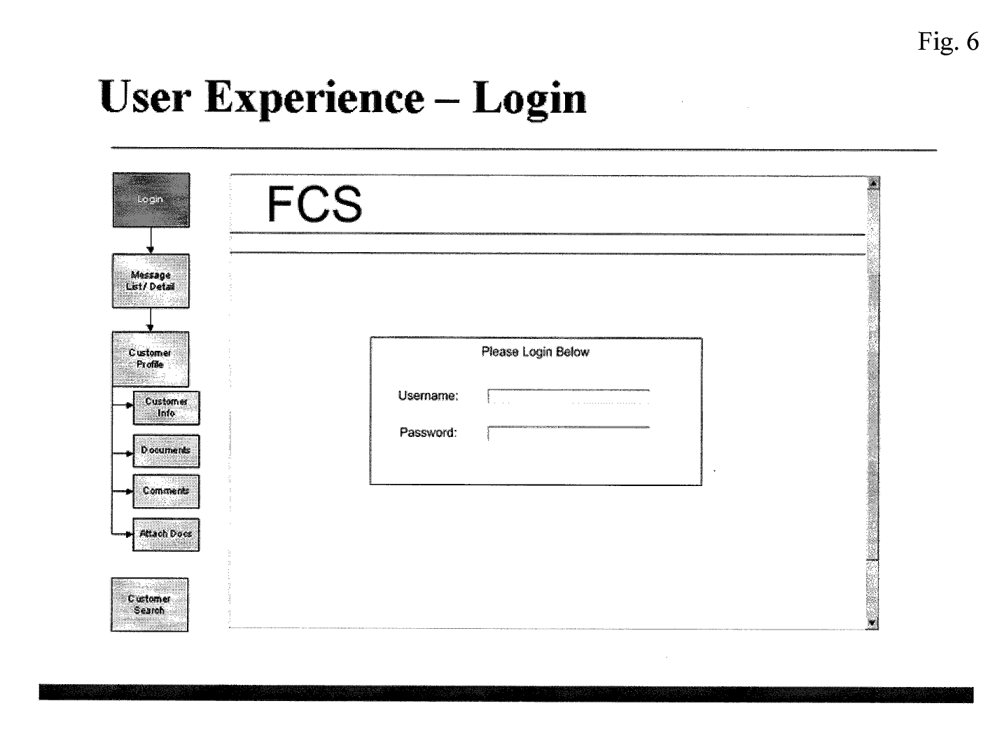

FIGS. 6-12 represent exemplary user interfaces that are used in conjunction with a customer profile. The customer profile can store any information related to a customer including, but not limited to, name, address, credit information, status information, bank statement information, financial information, identification information, comments, and documentation, or in general any information related to a centralized credit processing system.

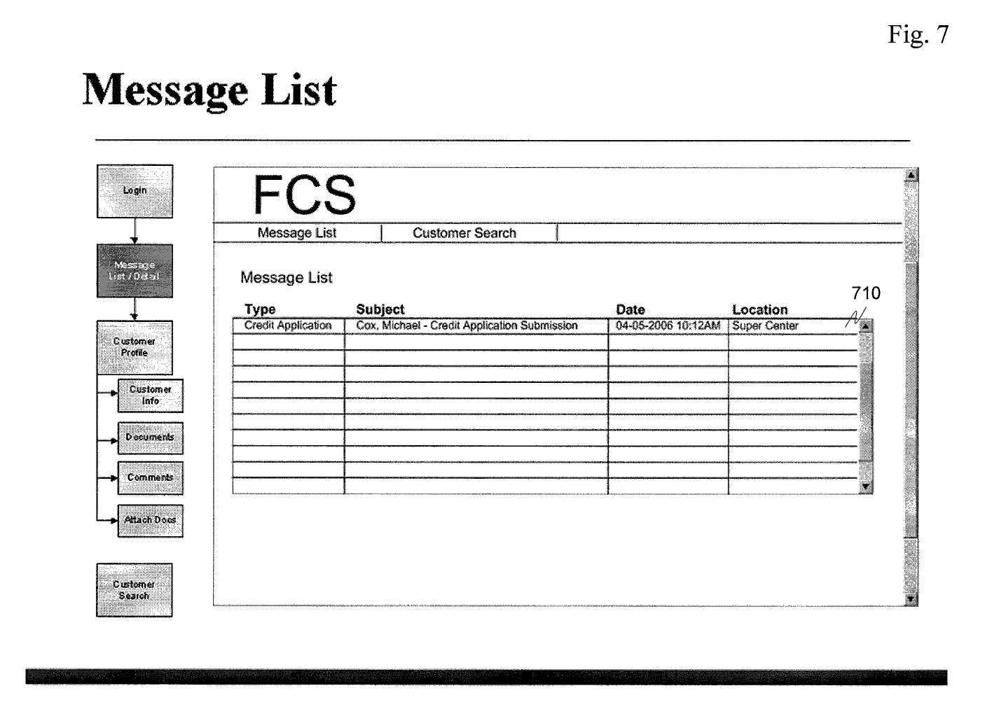

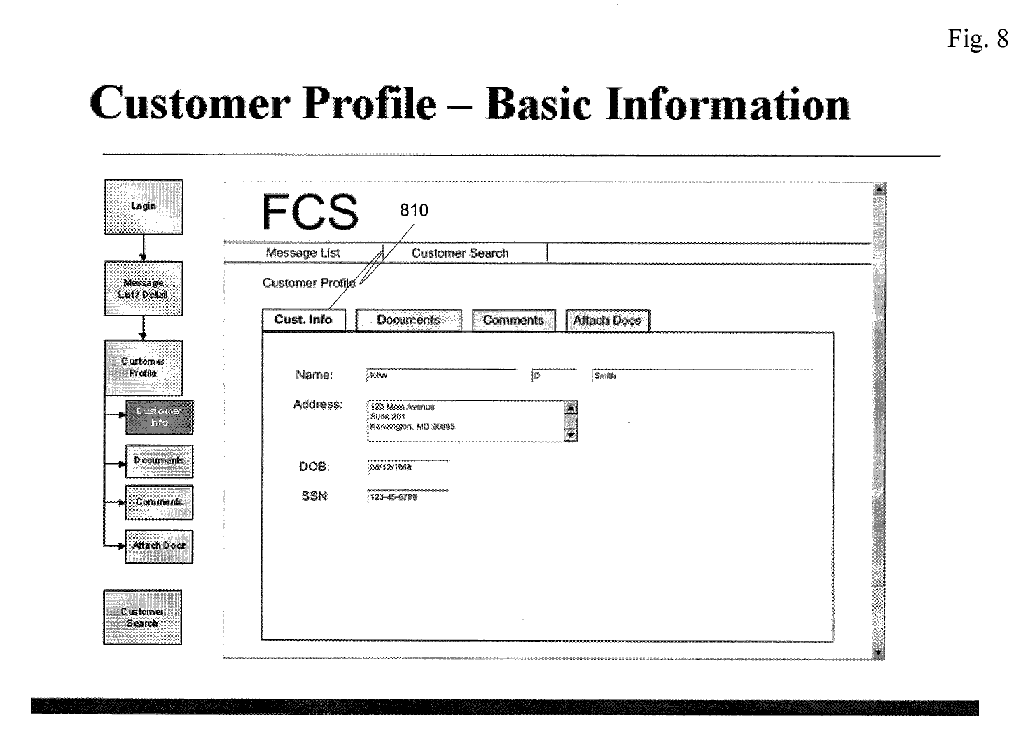

To gain access to a customer profile, a user logs in, for example, via the login interface illustrated in FIG. 6. Upon being granted access to the system, a summary of the information can be provided to a user such as that illustrated in FIG. 7. More specifically, a list of customer profiles 710 can be provided and ranked (or sorted), for example, based on there current status in the system, application date, salesperson, product or service type, or in general any criteria. From the list of customer profiles 710, or based on a search as discussed hereinafter, a specific customer profile can be selected as illustrated in FIG. 8. The customer profile 810 includes various information such as, but not limited to, name, address, date of birth and social security number. The customer information within the customer profile, as with the remainder of the information associated with the customer profile can be fully searchable.

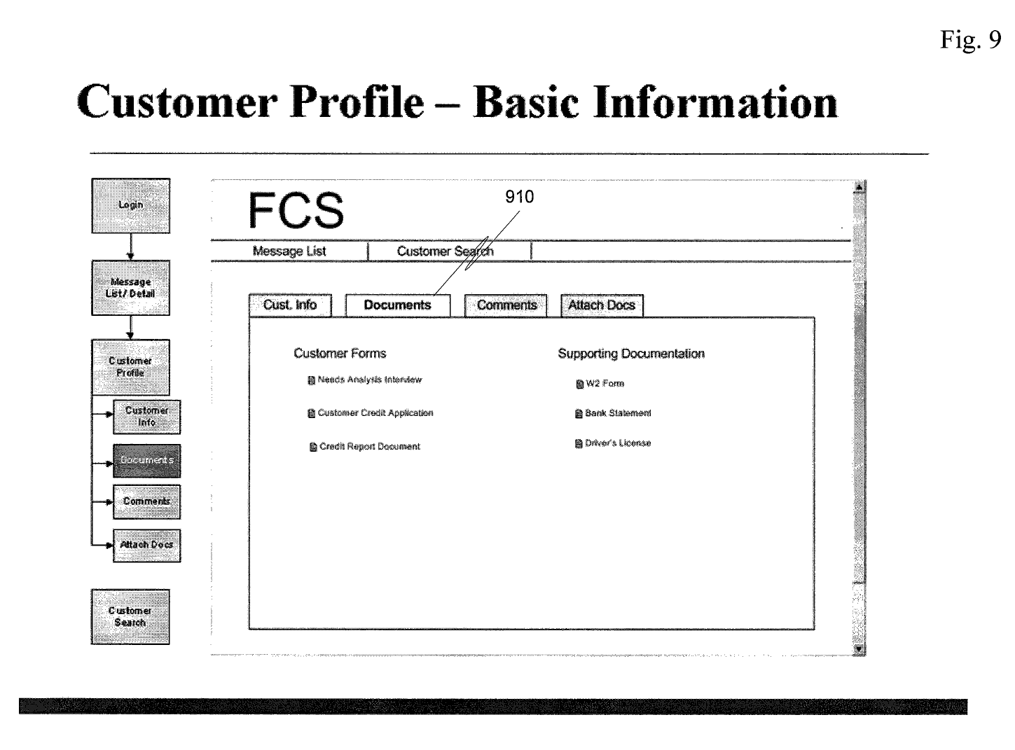

FIG. 9 illustrates the documents portion of the customer profile. In the documents portion 910, information such as customer forms and supporting documentation associated with the customer profile can be accessed. Exemplary forms include the credit application, the credit report, and supporting documentation can include W-2 forms, bank statements, a copy of a driver's license, paycheck stub(s), utility bills, or in general any information associated with the credit application process.

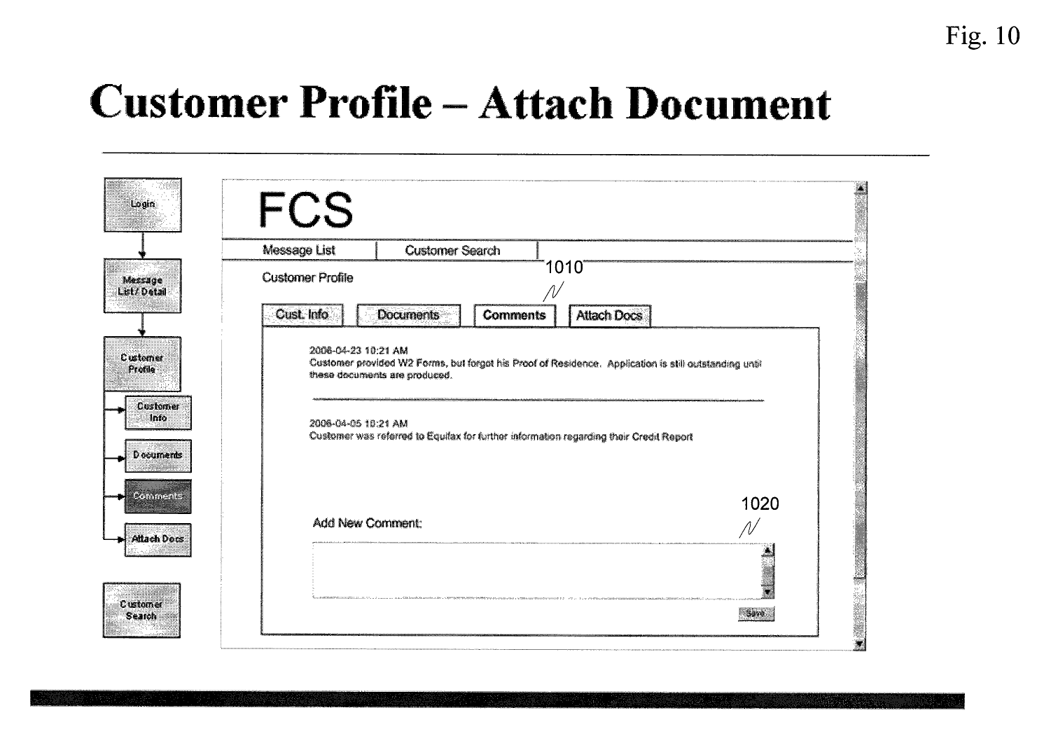

FIG. 10 grants users access to the comments portion of the customer profile. In this comments portion anyone associated with the transaction can include comments and have them associated with the customer profile. Also included in this interface is an add-new comments box 1020 that allows new comments to be added to and associated with the profile.

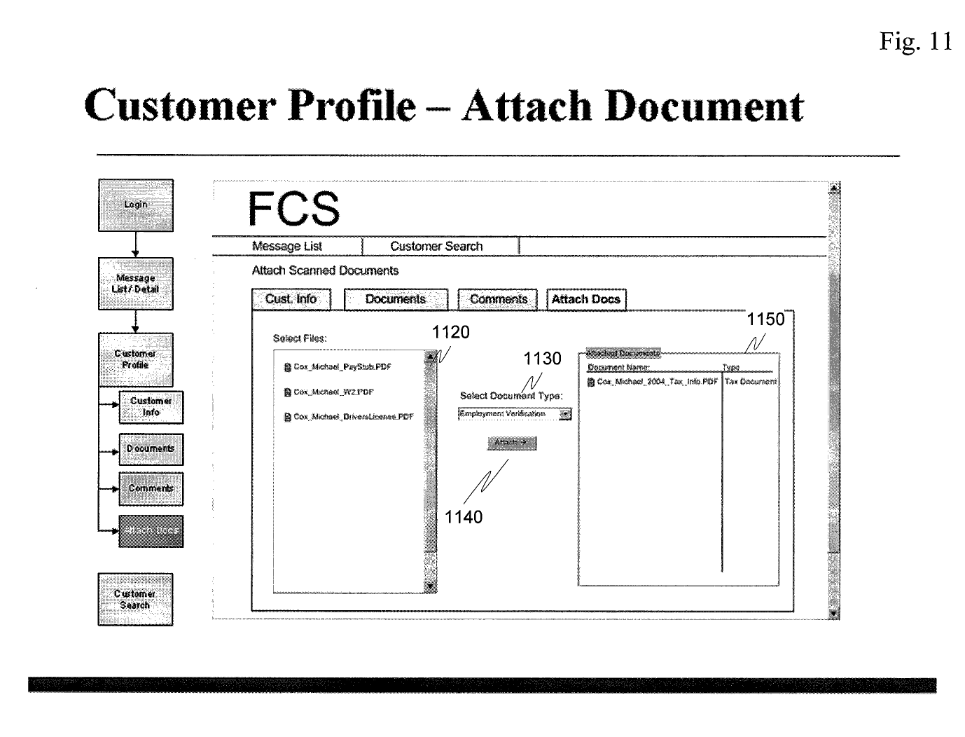

FIG. 11 allows a user to attach documents and have them associated with a customer profile. Documents can be from a scanner, received electronically, or in general any document can be associated with the customer profile. To attach a file, the user is presented with a select file interface 1120. Upon selection of a document from the select file interface 1120, a user can (optionally) select a document type to be associated with the selected file, and then attach the file by selecting the attach button 1140. The attached file is then shown as being associated with the customer profile in interface 1150.

In addition to traditional paper-based documentation, audio and video files can also be associated with and attached to a customer profile. For example, it may be advantageous to record and attach a copy of the interview between the loan applicant and an interviewer. Similarly, biometric information such as a fingerprint, or in general any biometric information can also be input into the system and associated with a customer profile.

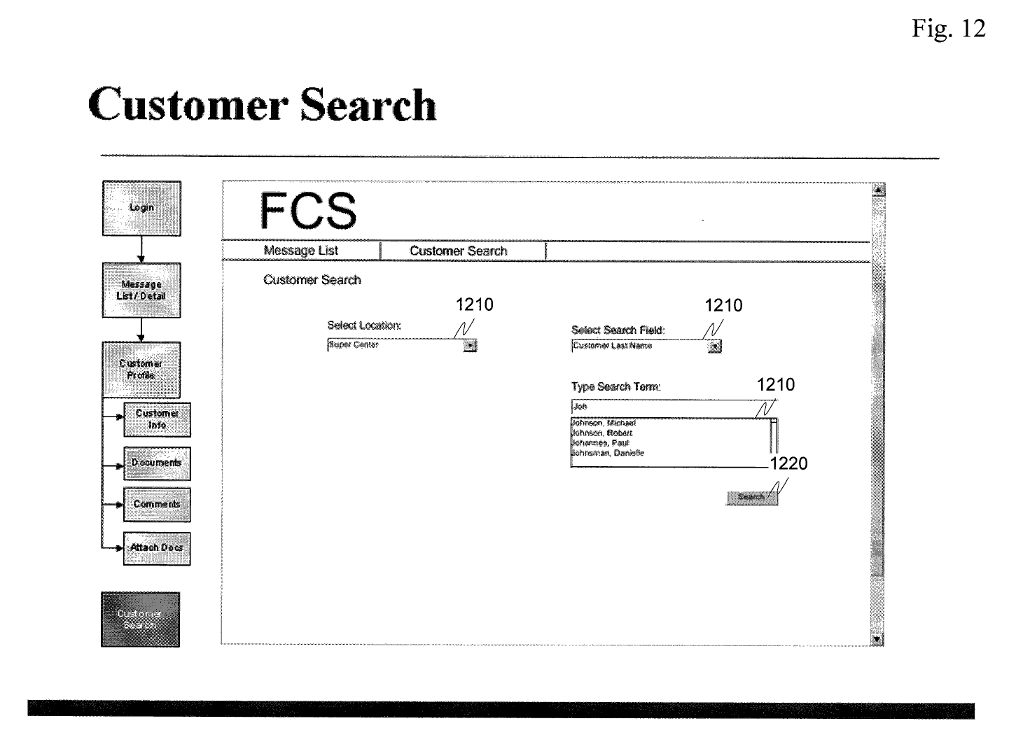

FIG. 12 is a customized query interface that allows a user to search for a customer based on, for example, store location, name, or in general any field or any information associated with the customer profile. For example, a user enters one or more search criteria in the search fields 1210 and, upon selection of the search button 1220 the system queries the database and displays all relevant customer profiles.

Furthermore, various types of reports can be run and generated, the reports summarizing any aspect of the centralized loan application and processing system.

While the above described methodology has been discussed in relation to a particular sequence of events, it should be appreciated that changes to this sequence can occur without materially effecting the operation of the invention.

The above-described systems and methods can be implemented on a computer server, personal computer, in a distributed processing environment, or the like, or on a separate programmed general purpose computer having database management, video conferencing and user interface capabilities. Additionally, the systems and methods of this invention can be implemented on a special purpose computer(s), a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, or the like, or a neural network and/or through the use of fuzzy logic. In general, any device capable of implementing a state machine that is in turn capable of implementing the flowcharts illustrated herein can be used to implement the invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The systems and methods illustrated herein however can be readily implemented in hardware and/or software using any known or later developed systems or structures, devices and/or software by those of ordinary skill in the applicable art from the functional description provided herein and with a general basic knowledge of the computer and data processing arts.

Moreover, the disclosed methods may be readily implemented in software executed on programmed general purpose computer, a special purpose computer, a microprocessor, or the like. Thus, the systems and methods of this invention can be implemented as program embedded on personal computer such as JAVA® or CGI script, as a resource residing on a server or graphics workstation, as a routine embedded in a dedicated credit application and processing system, or the like. The system can also be implemented by physically incorporating the system and method into a software and/or hardware system, such as the hardware and software systems of a credit and purchase management suite.

It is, therefore, apparent that there has been provided, in accordance with the present invention, systems and methods for centralized credit intake, processing and management. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. A centralized credit processing system comprising:
a credit operations center, in communication with a loan information data center, a credit bureau processing center and at least one bank, including
at least one interview room with video conferencing capabilities; and
at least one control center; and
at least one store location, each store location comprising:
at least one interview room with video conferencing capabilities;
a settlement room; and
an electronic credit application system,
the electronic credit application system querying a loan applicant for information related to a loan application and forwarding the information to the credit operations center for processing.

2. The system of claim 1, further comprising automatically requesting a credit bureau upon receipt of the information at the credit operations center.

3. The system of claim 1, further comprising real-time video conferencing capabilities between the at least one interview room in the credit operations center and the at least one interview room in the at least one store location.

4. The system of claim 1, further comprising one or more cameras, speakers, microphones and displays.

5. The system of claim 1, further comprising one or more scanners in communication with a loan information data center.

6. The system of claim 1, further comprising an inventory management system in communication with a control center, the inventory management system configured to determine available items for purchase at least based on a loan prequalification amount.

7. The system of claim 1, further comprising an inventory management system in communication with a control center, the inventory management system configured to determine available services for purchase at least based on a loan prequalification amount.

8. The system of claim 1, further comprising a call configuration bridge adapted to manage one or more of audio and video communication between the credit operations center and the one or more store locations.

9. The system of claim 1, further comprising a settlement area having an electronic signature capture system and a printer.

10. The system of claim 1, wherein the electronic credit application system further includes a controller, memory, communications device and a data input area, the electronic credit application system in communication with the credit operations center.

11. The system of claim 1, further comprising a customer profile, the customer profile being secure and at least storing the information related to the loan applicant.

12. The system of claim 1, wherein the credit operations center controls surveillance equipment at the one or more store locations.

13. A credit processing method comprising:
receiving an electronic credit application;
automatically running a credit bureau;
determining, based at least on the credit bureau, what products in inventory a loan applicant can afford;
determining, based at least on the credit bureau, whether a real-time video conference between a loan officer and the loan applicant is needed; and
finalizing a sale transaction.

14. The method of claim 13, further comprising presenting the loan applicant with disclosures and recording the loan applicant's response.

15. The method of claim 13, further comprising verifying, in real-time, information entered into the electronic credit application.

16. The method of claim 13, further comprising controlling surveillance at one or more store locations.

17. The method of claim 13, further comprising associating a checked-out electronic credit application device with a salesperson.

18. The method of claim 13, further comprising storing information related to the sale transaction in a secure customer profile.

19. The method of claim 13, further comprising displaying a camera feed from one or more store locations, interview rooms and settlement rooms to a control center.

20. The method of claim 13, further comprising maintaining communications between a credit operations center and one or more store locations with a call configuration bridge.

21. The method of claim 13, further comprising recording a loan applicant video conference interview and associating the recorded video conference interview with a customer profile.

22. The method of claim 13, further comprising printing a completed credit bureau and related information at a control center with an automatically generated cover sheet.

23. The method of claim 13, further comprising funding the sale transaction.

24. The method of claim 13, wherein the electronic credit application is capable of collecting information from a loan applicant that is in addition to that needed for a loan.

25. A credit processing system comprising:
means for receiving an electronic credit application;
means for automatically running a credit bureau;
means for determining, based at least on the credit bureau, what products in inventory a loan applicant can afford;
means for determining, based at least on the credit bureau, whether a real-time video conference between a loan officer and the loan applicant is needed; and
means for finalizing a sale transaction.
